(19) United States
(12) Patent Application Publication
(10) Pub. No.: US 2024/0212660 A1
(43) Pub. Date: Jun. 27, 2024

(54) USING ACOUSTIC EFFECT CONVERSION TO GENERATE LOW FREQUENCY SOUNDS WITH A SET OF TUNING FORKS

(71) Applicants: JANSEN MICHAEL, TANGERANG (ID); JANIA MICHAEL, TANGERANG (ID); MICHEL BUDI WIRJATMO, TANGERANG (ID)

(72) Inventor: MICHEL BUDI WIRJATMO, TANGERANG (ID)

(73) Assignees: JANSEN MICHAEL, TANGERANG (ID); JANIA MICHAEL, TANGERANG (ID); MICHEL BUDI WIRJATMO, TANGERANG (ID)

(21) Appl. No.: 18/146,361

(22) Filed: Dec. 24, 2022

(51) Int. Cl. G10H 3/20

(52) U.S. Cl. CPC G10H 3/20

(57) ABSTRACT

A computer configured for translating an audio input into a low frequency output using an acoustic effect conversion with a signal generator connected to the computer that takes the low frequency output and generates an electrical signal to drive a set of electromagnetic actuator couple to a set of N tuning forks, such that when the electromagnetic actuators are driven by the electrical signal the coupled tuning forks vibrate. The acoustic effect conversion translates the audio input into digital instructions, such as MIDI and may use a sequencer. The audio input may have a frequency IS and the electrical output signal may have a frequency LF and LF=IS/N, where N maybe 9 or 12. The audio input may use a digital analog file such as .wav or mp3. The N tuning forks may be in a circular pattern on a plane pointing away from the center.

### FIELD OF THE INVENTION

This invention is related to a device capable of producing low frequency sounds as directed by inputs, more specifically generating from an audio input low frequency sounds using a set of tuning forks.

### BACKGROUND OF THE INVENTION

Individual tuning forks can generate low frequency tones or air waves, and these low frequency tones or air waves from multiple tuning forks can combine to produce low frequency sounds. An example of a low frequency sound is an acoustic beat, which is an interference pattern between two tones of slightly different frequencies. Acoustic beats are perceived as a periodic variation in volume whose rate is the difference of the two frequencies. Tuning instruments, like tuning forks, that produce sustained tones can be used to produce lower frequency sounds like acoustic beats. The sound can be easily recognized when in the audio range.

The low frequency sounds can provide a unique listening experience for entertainment media. When in the audio range the low frequency sounds can be heard and when below audible range, sub-audible, the low frequency sounds can still be experienced by the listener in their body and can have an impression or impact on the listener. The impact on the listener is thought to improve emotional health, calming the mind, reduce stress/anxiety, and potentially have other beneficial impacts as well.

Low-frequency sounds are known for their ability to reach longer distances, due in part to the lower absorption when moving through air and their ability to move through solid materials, like walls and floors, while higher frequency tend to be blocked by walls and floors.

To date incorporating the low frequency sounds to accompany musical compositions with convenient computer control for playing them has not been possible.

What is needed is a convenient system to allow control and sequencing of low frequency sounds to be specified and played on demand.

### SUMMARY OF THE INVENTION

A system including a computer configured for translating an audio input into a low frequency output using an acoustic effect conversion. A signal generator is connected to the computer and takes the low frequency output to generate an electrical signal. One or more electromagnetic actuators are electrically coupled to the electrical signal. A set of N tuning forks with natural frequencies F1, to FN where FN is the highest frequency tuning fork where the one or more electromagnetic actuators are coupled to a tuning fork, such that when the one or more electromagnetic actuator is driven by the electrical signal the tuning fork vibrates.

The system may have the acoustic effect conversion translate the audio input into digital instructions, where the digital instructions may conform to MIDI. The system may have the acoustic effect conversion use a sequencer. The acoustic effect conversion may have the audio input which has a frequency IS and the electrical output signal has a frequency LF and the acoustic effect conversion includes LF=IS/N, where N may be nine or twelve. The system where the natural frequencies of the tuning forks are spaced evenly. The system where the audio input uses a digital analog file such as .wav or mp3 format. The system where the set of N tuning forks are arranged in a circular pattern on a plane with all the tuning forks having their axis aligned to the center of the circular pattern.

### BRIEF DESCRIPTION OF THE DRAWINGS

FIG. 1 illustrates a high-level block diagram of a low frequency sound machine that takes an audio input, does an acoustic effect conversion and produces low frequency sounds using a set of tuning forks.

FIG. 2 illustrates details of audio data conversion software that can do the acoustic sound conversion.

FIG. 3 illustrates details of the electronically controlled tuning fork set.

FIG. 4 illustrates for one tuning fork how an electrical signal produces tuning fork vibration sound.

FIG. 5 is a picture of an actual circuit board with an electromagnetic oscillator coupled to a tuning fork.

FIG. 6 is a table showing some example tuning fork driving frequencies for various audio input frequencies for a particular acoustic effect conversion.

### DETAILED DESCRIPTION

This document describes a low frequency sound machine that can take various inputs (be they analog or digital) apply an acoustic effect conversion and produce low-frequency tones or very low frequency tones that combine to produce low-frequency sounds.

The audio input may be automatically translated into a tone sequence or an ordered arrangement of tones to be produced by a tuning fork sound generator. The listener may or may not hear the sounds in their ear because if the sounds are low enough they may be below the level of human hearing, but still the listener will hear the sounds in the sense that they will impact their body.

The audio input may be a direct tone/frequency arrangement where the acoustic effect conversion is a direct mapping to provide the audio input control to vibrate individual tuning forks.

The audio input, even if in the audible range, may, once processed through the acoustic effect conversion, be in the inaudible range.

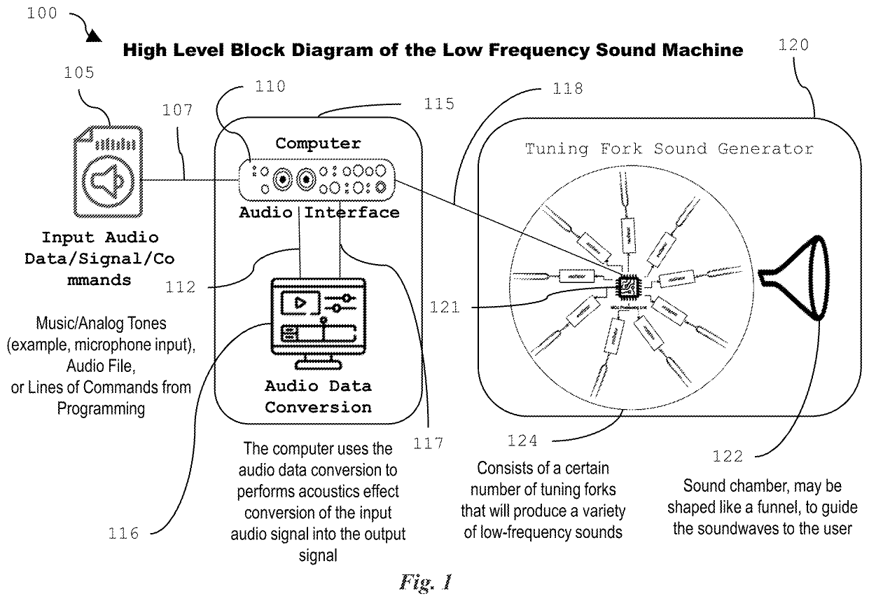

FIG. 1 is an illustration 100 of an implementation of a low frequency sound machine, starting with an audio input 105 that is shown connected via input connect 107 to an audio interface 110 of a computer 115 that may be connected via inbound internal wiring 112 to audio data conversion software 116 to perform an acoustic effect conversion on the audio input 105 into an output signal. The output signal may be sent via outbound internal wiring 117 to audio interface 110 over wire 118 to a Micro Controller Unit, MCU 121, in a tuning fork sound generator 120 to produce low frequency sounds using a set of N tuning forks 124 that may be directed through a sound chamber 122.

The audio input 105 may be music or tones or frequencies from analog and/or digital inputs such as WAV or MP3 files. An input device such as a microphone may provide audio input 105 as an analog signal. The audio input 105 may be from a live audio feed. A microphone is a transducer to convert acoustic energy (sound waves) into electrical signals. Basically, a microphone converts sound into electrical vibrations of an analog signal which can be the audio input 105. The audio input 105 may be digital signals received by the audio interface 110. The audio input 105 maybe generated by the computer 115 from of WAV or MP3 file.

The audio input 105 may be received via input circuits that may be inputted directly in the form of commands. For example, the command may be to vibrate a particular tuning fork, or may be to vibrate a specific set of tuning forks, or vibrate a tuning fork followed by another tuning fork, or vibrate a first set of tuning forks then a second set of tuning forks and then return to vibrating the first set of tuning forks again. In the case where the audio input 105 is a command the acoustic effect conversion may be rather straight forward with it even just being a straight mapping that when this input circuit (for example a key is pressed) then one specific tuning fork is vibrated.

The input connection 107 may be a wire or may be a wireless connection. For example, a wireless connection may use Wi-Fi, Bluetooth or other radio frequency communication.

The audio interface 110 may send and receive analog and digital audio signals. The Audio interface 110 may have an Analog to Digital Converter (ADC), Digital Signal Processor (DSP), and a Digital to Analog Converter (DAC). The ADC may convert the analog signal from the microphone into a digital signal. The ADC may be used to convert analog signals to digital numbers, and store them in a file like a “.wav” or “.mp3.” The DSP can process a starting digital audio track into a different digital audio track. The DAC (Digital Analog Converter) can convert digital audio data into analog output.

The audio interface 110 may have the ability to record real-time input, for example from a microphone or a live audio feed.

The audio interface 110 may include a sound card. A sound card is electronic hardware used for sound output generation. Historically seen as a complementary module, nowadays the sound card has become a necessity for a modern personal computer. To hear sound using a sound card, digital sound data (for example a digital sound file like a .wav or .mp3 format) may be sent to the sound card. The output from the sound card is an analog output signal (an electrical signal). The analog output signal may be amplified and outputted with an output device or module, for example output to a speaker.

On the computer 115 the audio data conversion software 116 may be used to perform an acoustic effect conversion. The acoustic effect conversion can be customized based on the desire preferences of a person configuring the low frequency sound machine. The person configuring the low frequency sound machine may be known as a configurator.

The acoustic effect conversion may use a number of technologies to convert the audio input 105 to an output signal.

The tuning fork sound generator 120 has a set of N tuning forks 124. The tuning fork sound generator 120 has been found to work good with the number of tuning forks being nine (N=9) or even better with the number of tuning forks being twelve (N=12). The background of the use of twelve tuning forks is the twelve notes obtained from 1 octave of the tone scale as commonly found in some musical instruments in general. The combination of these twelve basic notes have the ability to reproduce a wide range of sounds.

The computer 115 is where the output signal may be processed, stored and produced. The computer 115 may be Desktop PCs, Mini PCs, laptops, mobile devices such as mobile phones or tablets or other electronic computing environments.

The outbound internal wiring 117 may be internal data flow, where the low frequency sound machine may write numbers to a file and those numbers may represent analog signals, or other input data. The inbound internal wiring 112 and the outbound internal wiring 117 may share some or all their components.

The MCU 121 is shown in the center of the set of N tuning forks 124. The MCU may be a Central Processing Unit. The computer 115 may be a digital processor.

The tuning fork sound generator 120, may generate low-frequency sounds by vibrating the tuning forks using an electromagnetic coupled to the tuning forks. A number of tuning forks may be used to produce a desired frequency combination.

The produced low frequency sounds will be the result of some combination of the N tuning forks 124. The low frequency sound may be a simple waveform generated by one tuning fork or the low frequency sound may be an acoustic beat from two tuning forks, or the low frequency sound may be more complex sound from a set of tuning forks. The low frequency sound device may produce various sounds that may be used for entertainment purposes. The low-frequency sounds may be used by themselves or sequenced to make an arrangement of music, a part of an arrangement of music, an accompaniment to support an arrangement of music, an experience that is not audible. With either a single low frequency sound or a sequence of low frequency sounds it may produce a healing experience, a relaxation experience, or other beneficial experiences.

A speaker (for example, a loudspeaker, or stereo speaker) is a transducer that converts electrical signals into audio waves by a vibrating component such as a membrane to create air compression waves (i.e. sound waves). A sound may be amplified with the use of a microphone to pick up the sound that is then amplified and played on a speaker to extend the range the sound can be heard. The low frequency sound machine may incorporate a speaker to amplify the sounds produced by the set of N tuning forks 124.

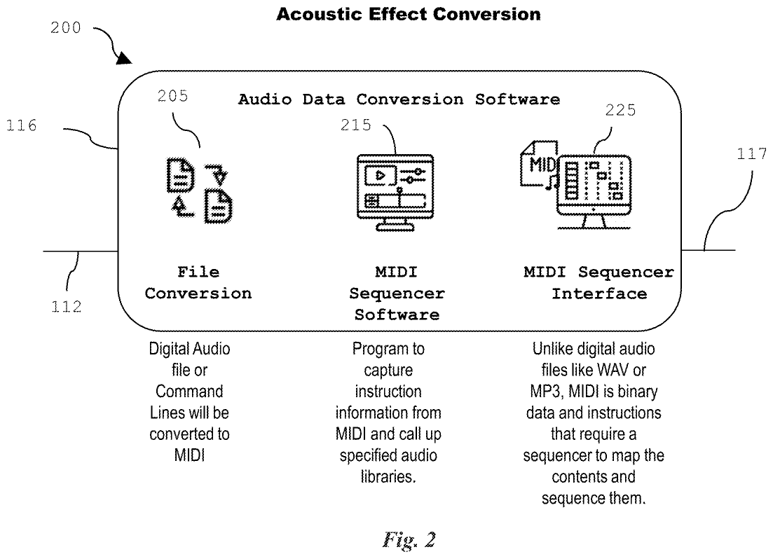

FIG. 2 illustrates diagram 200 showing details of how the low frequency sound machine can use the audio data conversion software 116 to implement an acoustic effect conversion. The audio data conversion software 116 may receive via inbound internal wiring 112 the audio input 105 that may be processed by a file conversion software 205, a sequencer software 215, and a sequencer interface 225. Then the Audio data conversion software 116 may provide the output signal to the audio interface 110 via the outbound internal wires 117.

The inbound internal wiring 112 may be internal data flow, where the low frequency sound machine may read numbers from a file and those numbers may represent analog signals, or other input data.

The acoustic effect conversion may use a power amplifier to ensure sounds are accurate by amplifying the audio input 105.

The file conversion software 205 may convert the audio input 105 into digital instructions like is found in a MIDI file. MIDI (Music Instruments Digital Interface), is an international hardware and software standard for exchanging data (such as music codes and MIDI events) between electronic music equipment and computers of various brands and manufacturers. Generally, MIDI is relatively small in size and is often used for outputting cell phone ringtones. MIDI cannot be viewed entirely as music because it does not contain sound, unlike digital music files such as MP3 or WAV. MIDI consists of rows of binary data that can be played on various electronic devices connected to synthesizers.

The MIDI file (sometimes a file with a “.mid” extension), can contain layers of digital musical instructions, which may include pitch, volume of each note, sound type, transport function (play, pause, stop), and other functions.

The file conversion software 205 may be an application or standardized software to convert the audio input 105 into a MIDI file format.

The sequencer software 215 may process the MIDI file and when certain digital instructions are detected in the MIDI file then the sequencer software 215 may retrieve specific audio from an audio library.

The sequencer software 215 may be used to record, edit, play music/tones, a complete sound library with notes and performance information in various forms, usually in MIDI or CV/Gate format, and possibly audio and automation data for DAWs (Digital Audio Workstation) and plug-in for examples plug-ins for enhanced audio-related functionality such as transforming existing audio samples, or generate new audio samples through sound synthesis.

This converting can be done in any number of ways, and the exact conversion may be setup by a configurator (a person or entity who configures) the low frequency sound machine. The configurator may pre-program the acoustic effect conversion to use a specific type of sound stored in a library of the sequencer software 215.

The acoustic effect conversion may use a collection of tone libraries that may be stored in the sequencer software 215.

For example, the acoustic effect conversion may use the sequencer software 215 to turn the audio input 105 into certain types of tones or sounds. For example, if a particular frequency is detected in the audio input 105, then the sequencer software 215 may call up a particular output sound, for example one stored in a library of the sequencer software 215.

The acoustic effect conversion may include combining the low-frequency tones derived from the data sequencer, and matches them with the desired frequency on the tuning fork sound generator 120.

The acoustic effect conversion may arrange a combination of low frequency outputs. These low frequency outputs may be sequenced in an order.

The acoustic effect conversion may use the sequencer software 215 to make calls to a tone library to retrieve specific tones.

The acoustic effect conversion may include the sequencing of tuning forks that may be adjusted on the computer 115 in the audio data conversion software 116. The adjustment may be based on the frequency range belonging to each tuning fork to be vibrated. The tuning forks may be activated simultaneously and the acoustic effect conversion may create a sequence of different sets of tuning forks being vibrated. The acoustic effect conversion may be adjusted by the configurator to produce a desired acoustic effect.

The acoustic effect conversion may include the use of a digital processor.

The sequencer interface 225 may process the MIDI digital instructions and map the content into a sequence of output signals.

The digital instructions, for example like those stored in a MIDI file may be converted using the sequencer interface 225 into a specific type of tone or sound.

The process of combining low-frequency tones from the digital instructions will be carried out by matching the digital instructions with the desired frequency on the tuning fork sound generator 120 on the computer 115, to produce low-frequency sounds from the vibration of the tuning fork through an electromagnetic oscillator.

The individual tuning fork tones form the base sounds that may be combined produce a wide range of sounds at various frequencies.

To produce a harmonious frequency, the way the tuning fork sound generator 120 works may resemble a musical instrument where each tuning fork may have a certain driving oscillator frequency range that may be played (i.e. vibrated). The tuning forks may be played simultaneously or alternating with other tuning forks, like a musical instrument.

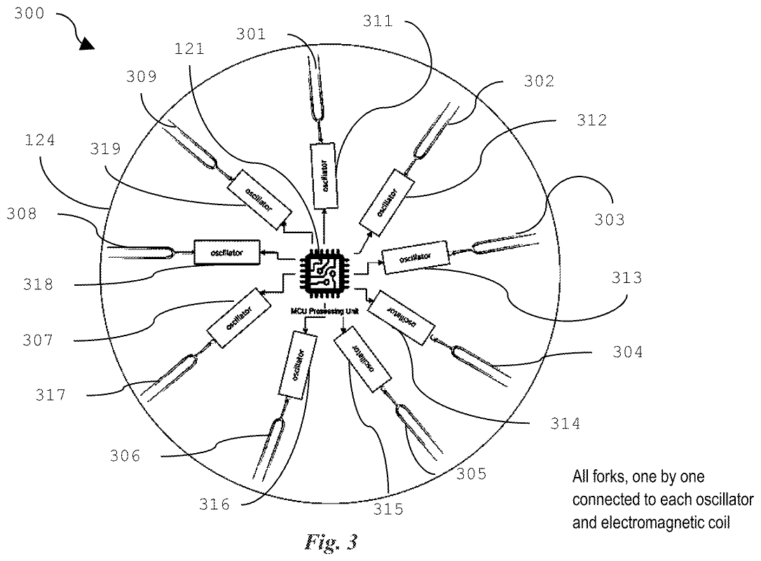

FIG. 3 provides illustration 300 of the set of N tuning forks 124 with nine tuning forks (N=9), having the properties specified as follows:
The first tuning fork TF1 301 is vibrated by oscillator 311 and will have the lowest natural frequency in the set of N tuning forks 124.
The second tuning fork TF2 302 is vibrated by oscillator 312 and may have a natural frequency higher than TF1.
The third tuning fork TF3 303 is vibrated by oscillator 313 and may have a natural frequency higher than TF2.
The fourth tuning fork TF4 304 is vibrated by oscillator 314 and may have a natural frequency higher than TF3.
The fifth tuning fork TF5 305 is vibrated by oscillator 315 and may have a natural frequency higher than TF4.
The sixth tuning fork TF6 306 is vibrated by oscillator 316 and may have a natural frequency higher than TF5.
The seventh tuning fork TF7 307 is vibrated by oscillator 317 and may have a natural frequency higher than TF6.
The eighth tuning fork TF8 308 is vibrated by oscillator 318 and may have a natural frequency higher than TF7.
The ninth tuning fork TF9 309, also known as TFN, is vibrated by oscillator 319 and will have the highest natural frequency in the set of N tuning forks 124.

The oscillators, 311, 312, 313, 314, 315, 316, 317, 318 and 319 are connected to the Micro Control Unit, MCU 121, where the MCU 121 may provide the oscillator with instruction to oscillate and at what frequency, or the MCU 121 may provide the oscillating signal for the electromagnet.

The frequency spacing between the tuning forks may be logarithmically space as tradition in sheet music and notes on a piano. The frequency spacing between the tuning forks may be consistently spaced, with the same change in frequency between the tuning forks, for example with 50 Hz increase in the natural frequency between the tuning forks.

The number of tuning forks may be nine, N=9, and the natural frequency of each tuning fork may be in the range indicated as follows:
Tuning Fork 1, range: 0.5-350 Hz
   Tuning Fork 2, range: 1-400 Hz
Tuning Fork 3, range: 1.5-450 Hz
Tuning Fork 4, range: 2-500 Hz
Tuning Fork 5, range: 2.5-550 Hz
Tuning Fork 6, range: 3-600 Hz
Tuning Fork 7, range: 3.5-650 Hz
Tuning Fork 8, range: 4-700 Hz
Tuning Fork 9, range: 4.5-750 Hz

The number of tuning forks may be twelve, N=12, and the tuning forks may have a natural frequency in the range indicated as follows:
Tuning Fork 1, range: 0.5-350 Hz
Tuning Fork 2, range: 1-400 Hz
Tuning Fork 3, range: 1.5-450 Hz
Tuning Fork 4, range: 2-500 Hz
Tuning Fork 5, range: 2.5-550 Hz
Tuning Fork 6, range: 3-600 Hz
Tuning Fork 7, range: 3.5-650 Hz
Tuning Fork 8, range: 4-700 Hz
Tuning Fork 9, range: 4.5-750 Hz
Tuning Fork 10, range: 5-800 Hz
Tuning Fork 11, range: 5.5-850 Hz
Tuning Fork 12, range: 6-900 Hz

The set of N tuning forks 124 may be physically arranged in a circular pattern with a radius of 1 cm to 4 cm from the center of the tuning forks. The angle between the tuning forks may be set so the tuning forks are spaced evenly around the circle. So, for example for N=9 the tuning forks may be placed at forty degrees from each other, for N=12 the tuning forks may be placed at thirty degrees from each other. Between one tuning fork and the next tuning fork there may be a distance of 1-3 cm at the base. The distance from the central point, for example the center point of a circle, to the bottom of the tuning fork may be between 2-5 cm.

The low frequency sounds produced by the low frequency sound machine is a combination and sequencing of tuning forks in the set of N tuning forks 124 that produce a combination of N basic notes. The set of N tuning forks 124 may produce a wide variety of sounds with various combination of the N tuning forks in the set of N tuning forks 124.

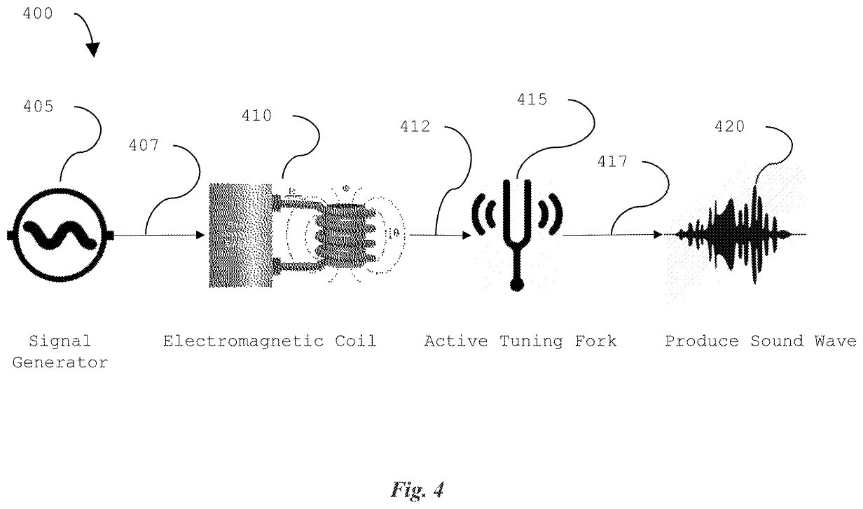

FIG. 4 provides a block diagram 400 showing the output signal from a signal generator 405 travelling on wires 407 to drive the electromagnetic coil 410 that can physically engage 412 the tuning fork 415 that vibrates 417 producing sounds 420.

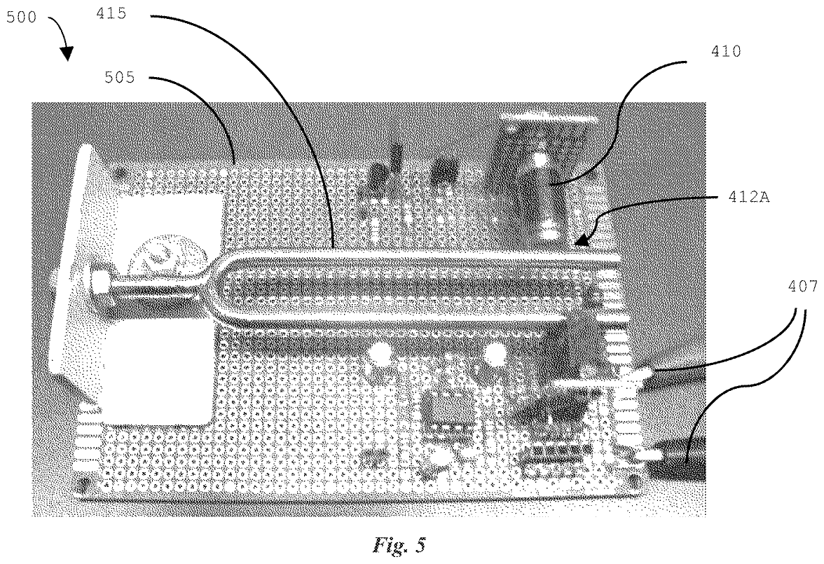

FIG. 5 provides picture 500 of a perf circuit board 505 with the wires 407 providing signal to the electromagnetic coil 410 to create movement at physical contact point 415A. When the tuning fork 415 is struck the tuning fork 415 vibrates, for example vibrating at it natural frequency.

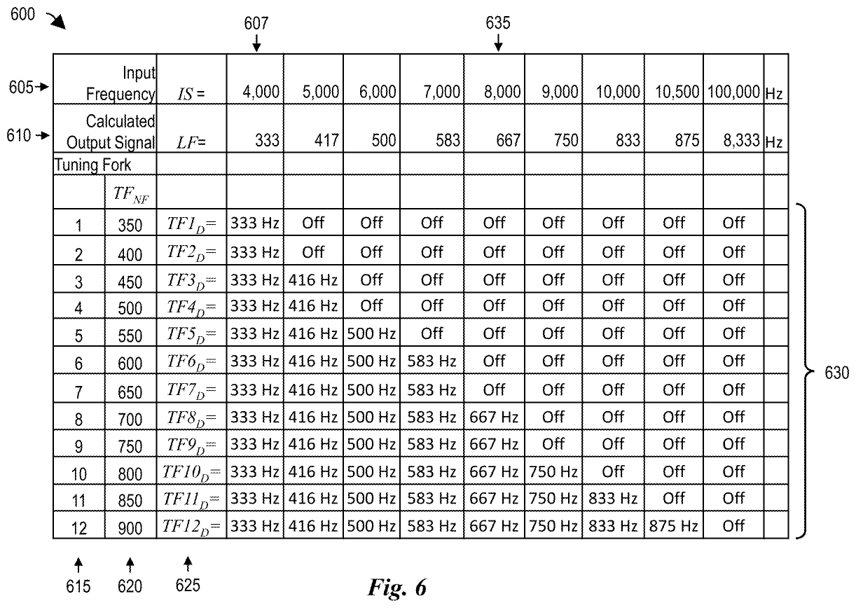

FIG. 6 shows table 600 with the result of certain input frequencies being processed through a particular acoustic effect conversion.

The table 600 show the results the following acoustic effect conversion for a N tuning fork 124 where N=12 and the conversion implement is as follows:
The acoustic effect conversion may have the low frequency signal, LS, equal to the frequency of the audio input 105, IS, divided by the number of tuning forks, or as written in an equation:

LS=IS/N,
And where if N=12
then LS=IS/12
The low frequency sound machine will use a driving oscillating frequency TF12_{D} on Tuning Fork 12 (that has a natural vibration frequency TF12_{NF}, for example 900 Hz), where TF12_{D} is set as follows:
   if LS>TF12_{NF} then TF12_{D}=0 Hz,
   else TF12_{D}=LS.
The low frequency sound machine will use a driving oscillating frequency TF11_{D} on Tuning Fork 11 (that has a natural vibrating frequency TF11_{NF}, for example 850 Hz), where TF11_{D} is set as follows:
   if LS>TF11_{NF} then TF11_{D}=0 Hz,
   else TF11_{D}=LS.
The low frequency sound machine will use a driving oscillating frequency TF10_{D} on Tuning Fork 10 (that has a natural vibrating frequency TF10_{NF} , for example 800 Hz), where TF10_{D} is set as follows:
   if LS>TF10_{NF} then TF10_{D}=0 Hz,
   else TF10_{D}=LS.
The low frequency sound machine will use a driving oscillating frequency TF9_{D} on Tuning Fork 9 (that has a natural vibrating frequency TF9_{NF}, for example 750 Hz), where TF9_{D} is set as follows:
   if LS>TF9_{NF} then TF9_{D}=0 Hz,
   else TF9_{D}=LS.
The low frequency sound machine will use a driving oscillating frequency TF8_{D} on Tuning Fork 8 (that has a natural vibrating frequency TF8_{NF}, for example 700 Hz), where TF8_{D} is set as follows:
   if LS>TF8_{NF} then TF8_{D}=0 Hz,
   else TF8_{D}=LS.
The low frequency sound machine will use a driving oscillating frequency TF7_{D} on Tuning Fork 7 (that has a natural vibrating frequency TF7_{NF}, for example 650 Hz), where TF7_{D} is set as follows:
   if LS>TF7_{NF} then TF7_{D}=0 Hz,
   else TF7_{D}=LS.
The low frequency sound machine will use a driving oscillating frequency TF6_{D} on Tuning Fork 6 (that has a natural vibrating frequency TF6_{NF}, for example 600 Hz), where TF6_{D} is set as follows:
   if LS>TF6_{NF} then TF6_{D}=0 Hz,
   else TF6_{D}=LS.
The low frequency sound machine will use a driving oscillating frequency TF5_{D} on Tuning Fork 5 (that has a natural vibrating frequency TF5_{NF}, for example 550 Hz), where TF5_{D} is set as follows:
   if LS>TF5_{NF} then TF5_{D}=0 Hz,
   else TF5_{D}=LS.
The low frequency sound machine will use a driving oscillating frequency TF4_{D} on Tuning Fork 4 (that has a natural vibrating frequency TF4_{NF}, for example 500 Hz), where TF4_{D} is set as follows:
   if LS>TF4_{NF} then TF4_{D}=0 Hz,
   else TF4_{D} =LS.
The low frequency sound machine will use a driving oscillating frequency TF3_{D} on Tuning Fork 3 (that has a natural vibrating frequency TF3_{NF}, for example 450 Hz), where TF3_{D} is set as follows:
   if LS>TF3_{NF} then TF3_{D}=0 Hz,
   else TF3_{D}=LS.
The low frequency sound machine will use a driving oscillating frequency TF2_{D} on Tuning Fork 2 (that has a natural vibrating frequency TF2_{NF}, for example 400 Hz), where TF2_{D} is set as follows:
   if LS>TF2_{NF} then TF2_{D}=0 Hz,
   else TF2_{D}=LS.
The low frequency sound machine will use a driving oscillating frequency TF1_{D} on Tuning Fork 1 (that has a natural vibrating frequency TF1_{NF}, for example 350 Hz), where TF1_{D} is set as follows:
   if LS>TF1_{NF} then TF1_{D}=0 Hz,
   else TF1_{D}=LS.

FIG. 6 has a table 600 with a top row 605 containing the input sound frequency, IS, starting in column three. The second row 610 shows the calculated low frequency signal, LF, that was calculated by taking IS from the top row 605 and dividing it by 12, where 12 indicates the number of tuning forks. The bottom portion of the table starts with the first column 615 that indicates the tuning fork number. The next column 620 has the natural frequency for the tuning fork, where each row in the table corresponds to a tuning fork. The third column 625 provides the tuning fork number driving oscillating frequency. The body of the table 630 indicates what the driving oscillating frequency is for a given tuning fork for a given input signal frequency. So, for example, looking at columns 635 the input frequency is 8,000 Hertz which provides a low calculator low frequency output signal of 667 Hertz. Continuing down that column the first six tuning forks, number 1-7, will not be oscillating. tuning Forks 8 through 12 will be oscillated at a frequency of 667 Hertz (the low frequency LF from the second rows 610). In this particular case the tuning fork driving frequencies are the same across all the active tuning forks.

This provides just one example of an acoustic effect conversion that takes an audio input 105, and based on its frequency, IS, converts it to the LF output signal that drives the magnetic oscillator to vibrate some or all of the set of N tuning forks 124.

Alterations and deviations from the described device are expected by others and the device may be further developed to fulfill the described objectives and other objectives, and the scope is not limited to what is described above but rather it is determined by the breadth of the accompanying claims.

1. A system comprising a computer configured for translating an audio input into a low frequency output using an acoustic effect conversion;
a signal generator connected to the computer that takes the low frequency output and generates an electrical signal;
one or more electromagnetic actuators electrically coupled to the electrical signal; and
a set of N tuning forks with natural frequencies F₁ , to F_{N} where F_{N} is the highest frequency tuning fork and N is the number of tuning forks, where the one or more electromagnetic actuators are coupled to a tuning fork from the set of N tuning forks, such that when the one or more electromagnetic actuator is driven by the electrical signal the tuning fork vibrate.

2. The system of claim 1 where the acoustic effect conversion translates the audio input into digital instructions.

3. The system of claim 2 where the digital instructions conform to a standard musical instrument digital interface format.

4. The system of claim 1 where the acoustic effect conversion uses a sequencer.

5. The system of claim 1 where the audio input has a frequency IS and the electrical signal has a frequency LF and the acoustic effect conversion includes LF=IS/N.

6. The system of claim 1 where N is 9 or 12.

7. The system of claim 1 where the natural frequencies of the tuning forks in the set of N tuning forks are spaced evenly.

8. The system of claim 1 where the audio input uses a digital analog file.

9. The system of claim 8 where the digital analog file is .wav or mp3 format.

10. The system of claim 1 where the set of N tuning forks are arranged in a circular pattern on a plane, where the circular pattern has a center and all the tuning forks having their axis aligned to the center.

11. A system comprising a set of N tuning forks each with a base and an axis and with natural frequencies F₁, to F_{N} where F_{N} is the highest natural frequency, and where N is the number of tuning forks, where the set of N tuning forks are arranged in on a plane with all the axis of the tuning forks align to a center point; and
one or more electromagnetic actuators, where at least one tuning fork in the set of N tuning forks is coupled to an electromagnetic actuator from the one or more electromagnetic actuators, such that when the electromagnetic actuator is activated the at least one tuning fork vibrates.

12. The system of claim 11 where N is 9.

13. The system of claim 11 where N is 12.

14. The system of claim 11 where the natural frequencies of the set of N tuning forks are spaced evenly.

15. The system of claim 11 where the base of the tuning forks are more than 1 centimeter from the center point.

16. The system of claim 15 where the base of the tuning forks are less than 4 centimeters from the center point.

17. The system of claim 11 where the tuning forks are enclosed in a sound chamber that when a tuning fork makes a sound wave the sound wave is directed in a particular direction.

18. The system of claim 11 further comprising:
an electrical signal generator that generates an electrical signal with a frequency, where the electrical signal is connected to the one or more electromagnetic actuators such that when the electrical signal is sent the tuning fork vibrates; and
a computer connected to the electrical signal generator that controls the frequency of the electrical signal, where the computer takes an audio input and creates a low frequency signal using an acoustic effect conversion.

19. A system comprising:
a set of N tuning forks, F₁to F_{N}, where the set of N tuning forks are arranged in on a plane with all the tuning forks pointing out from a central point; and
one or more electromagnetic actuators, where at least one tuning fork in the set of N tuning forks is coupled to the one or more electromagnetic actuators;
an electrical signal generator that generates an electrical signal, where the electrical signal is connected to the one or more electromagnetic actuators such that when the electrical signal is sent the at least one tuning fork vibrates; and
a computer connected to the electrical signal generator that set a frequency of the electrical signal, where the computer takes an audio input and creates the electrical signal using an acoustic effect conversion.

20. The system of claim 19
where the audio input has a frequency IS and the electrical signal has a frequency LF and the acoustic effect conversion includes LF=IS/N, where N is the number of tuning fork in the set of N tuning forks.
